(19) United States
(12) Patent Application Publication
(10) Pub. No.: US 2026/0292389 A1
(43) Pub. Date: Sep. 24, 2026

(54) Stable Electro-Magnetic Valve for Intentional Leak or Tuning Applications

(71) Applicant: Apple Inc., Cupertino, CA (US)

(72) Inventors: Onur I. Ilkorur, Santa Clara, CA (US); Christopher Wilk, Los Gatos, CA (US); Scott C. Grinker, Belmont, CA (US); Bonnie W. Tom, Wheat Ridge, CO (US)

(21) Appl. No.: 19/458,076

(22) Filed: Jan. 23, 2026

Related U.S. Application Data
(60) Provisional application No. 63/773,754, filed on Mar. 18, 2025.

(51) Int. Cl. H04R 1/10; F16K 31/06

(52) U.S. Cl. CPC H04R 1/1091; F16K 31/0668

(57) ABSTRACT

A portable electronic device comprising: an enclosure having an enclosure wall that forms an interior chamber surrounding a transducer and an opening from the interior chamber; and an electro-magnetic valve coupled to the opening and comprising a stationary portion that is energized upon application of a voltage to drive a movement of a movable portion between a first state and a second state operable to close or open the opening.

### RELATED APPLICATIONS

This application claims the benefit of priority of U.S. Provisional Application No. 63/773,754, filed Mar 18, 2025, which is herein incorporated by reference.

### FIELD

An aspect of the disclosure is directed to a stable electro-magnetic valve for an electronic device. Other aspects are also described and claimed.

### BACKGROUND INFORMATION

Electronic devices (e.g., desktop computers, desktop speakers, smart phones, earphones, etc.) have within them one or more transducers that convert an input electrical audio signal into a sound pressure wave output that can be heard by the user, or a sound pressure wave input into an electrical audio signal. The transducer (e.g., a speaker) can be used to, for example, to output sound pressure waves corresponding to the voice of a far end user, such as during a telephone call, or to output sound pressure waves corresponding to sounds associated with music or a game the user wishes to play. Due to the relatively low profile of these electronic devices, the transducers also have a relatively low profile, which in turn, can make it difficult to maintain optimal sound quality.

### SUMMARY

An aspect of the disclosure is directed to a stable electro-magnetic valve that can be placed between two air volumes or cavities which will enable the communication between those two cavities on demand to change one or more performance metrics of the system and/or achieve an acoustic and/or thermal-physical comfort level desired by the user. For example, in some aspects, the valve can enable communication between a transducer front volume located within an earpiece within an ear of the user and a surrounding ambient environment to reduce humidity and/or heat buildup in the ear canal. In other aspects, the valve can reduce foot fall or other unwanted side effects that occur when the earphone is tightly sealed to the ear canal. In addition, the valve may be used to enable acoustic and thermal communications between the ear canal and the earphone positioned in the ear canal to improve comfort and provide a more open feel. In some aspects, the valve may be bistable and have an open or a closed condition, position or state in which it is stable, or it can be designed to be stable at multiple locations and can be adjusted incrementally to have a variable opening area depending on the desired acoustic and/or thermal-physical comfort of the user.

Representatively, in some aspects the disclosure is directed to a portable electronic device including an enclosure having an enclosure wall that forms an interior chamber surrounding a transducer and an opening from the interior chamber; and an electro-magnetic valve coupled to the opening and comprising a stationary portion that is energized upon application of a voltage to drive a movement of a movable portion between a first state and a second state operable to close or open the opening. In some aspects, the electro-magnetic valve comprises a bistable electro-magnetic valve. In further aspects, the movable portion comprises an elongated member that slides across the opening to the first state to close the opening and the second state to open the opening. In other aspects, the stationary portion comprises a pair of magnets and a pair of coils that are energized to move a steel bar of the movable portion between the first state and the second state to close or open the opening. In still further aspects, each magnet of the pair of magnets and each coil of the pair of coils are positioned near ends of the steel bar, and the stationary portion further comprises a damping member positioned between each of the ends of the steel bar and each magnet. In other aspects, the opening comprises a number of openings and the movable portion comprises a number of protrusions, and the number of protrusions cover at least one of the number of openings in the first state to close the opening. In still further aspects, the number of protrusions cover all of the number of openings in the first state to close the opening. In some aspects, the first state corresponds to a first acoustic impedance in which the opening is substantially closed and the second state corresponds to a second acoustic impedance in which the opening is substantially open.

In still further aspects, the enclosure wall comprises a curved interior surface and the movable portion comprises a curved steel bar that slides along the curved interior surface of the enclosure wall. In other aspects, the opening is through a portion of the enclosure wall that separates the interior chamber from an ambient environment, and wherein opening and closing the opening opens and closes the interior chamber to the ambient environment.

In other aspects, a valve assembly for a portable electronic device includes an electro-magnetic valve coupled to an opening defined by an enclosure wall that forms an interior chamber surrounding a transducer. The electro-magnetic valve may include a stationary portion that is energized upon application of a voltage to drive a movement of a movable portion between a first state and a second state operable to close or open the opening. In some aspects, the electro-magnetic valve comprises a bistable electro-magnetic valve. In other aspects, the movable portion comprises an elongated member that slides across the opening to the first state to close the opening and the second state to open the opening. In still further aspects, the stationary portion comprises a pair of magnets and a pair of coils that are energized to slide a steel bar of the movable portion through the pair of coils between the first state and the second state to close or open the opening. In other aspects, each magnet of the pair of magnets and each coil of the pair of coils are positioned near ends of the steel bar, and the stationary portion further comprises a damping member positioned between each of the ends of the steel bar and each magnet. In some aspects, the opening comprises a number of openings and the movable portion comprises a number of protrusions, and the number of protrusions cover at least one of the number of openings in the first state to close the opening. In other aspects, the number of protrusions cover all of the number of openings in the first state to close the opening. In still further aspects, the first state corresponds to a first acoustic impedance in which the opening is substantially closed and the second state corresponds to a second acoustic impedance in which the opening is substantially open. In some aspects, the enclosure wall comprises a curved interior surface and the movable portion is curved and slides along the curved interior surface of the enclosure wall. In some aspects, the opening is through a portion of the enclosure wall that separates the interior chamber from an ambient environment, and wherein opening and closing the opening opens and closes the interior chamber to an ambient environment.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

FIG. 1 illustrates a cross-sectional side view of one aspect of an electronic device.

FIG. 2 illustrates a cross-sectional side view of one aspect of an electronic device.

FIG. 3 illustrates a cross-sectional side view of one aspect of an electronic device.

FIG. 4 illustrates a cross-sectional side view of one aspect of an electronic device.

FIG. 5 illustrates a cross-sectional side view of one aspect of an electronic device.

FIG. 6 illustrates a cross-sectional side view of one aspect of an electronic device.

FIG. 7 illustrates a block diagram of one aspect of an electronic device within which a transducer including the valve assembly of FIG. 1-FIG. 6 may be implemented.

### DETAILED DESCRIPTION

In this section we shall explain several preferred aspects of this disclosure with reference to the appended drawings. Whenever the shapes, relative positions and other aspects of the parts described are not clearly defined, the scope of the disclosure is not limited only to the parts shown, which are meant merely for the purpose of illustration. Also, while numerous details are set forth, it is understood that some aspects of the disclosure may be practiced without these details. In other instances, well-known structures and techniques have not been shown in detail so as not to obscure the understanding of this description.

The terminology used herein is for the purpose of describing particular aspects only and is not intended to be limiting of the disclosure. Spatially relative terms, such as "beneath", "below", "lower", "above", "upper", and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as "below" or "beneath" other elements or features would then be oriented "above" the other elements or features. Thus, the exemplary term "below" can encompass both an orientation of above and below. The device may be otherwise oriented (e.g., rotated 90 degrees or at other orientations) and the spatially relative descriptors used herein interpreted accordingly.

As used herein, the singular forms "a", "an", and "the" are intended to include the plural forms as well, unless the context indicates otherwise. It will be further understood that the terms "comprises" and/or "comprising" specify the presence of stated features, steps, operations, elements, and/or components, but do not preclude the presence or addition of one or more other features, steps, operations, elements, components, and/or groups thereof.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

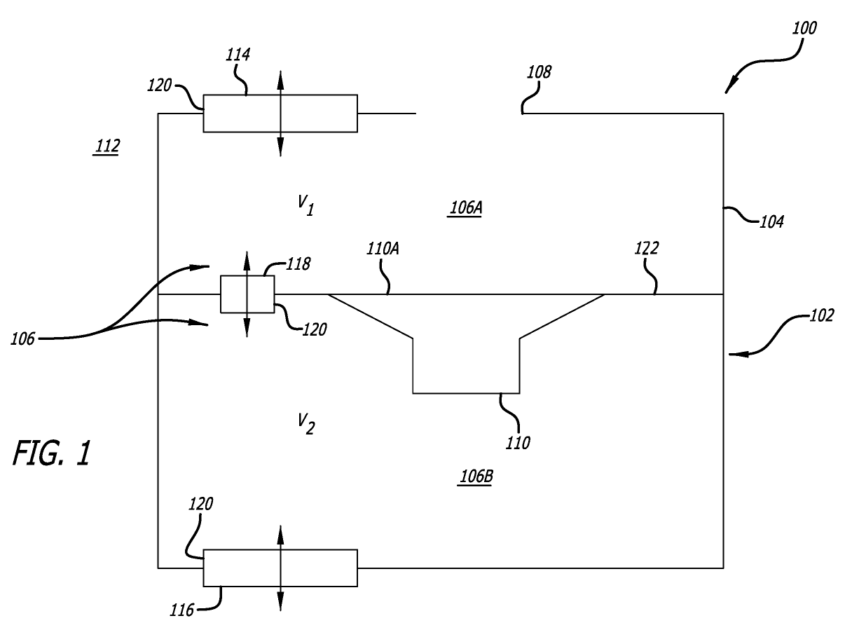

FIG. 1 illustrates a cross-sectional side view of one aspect of a valve assembly for a transducer positioned within a portable electronic device. The electronic device 100 may include a housing, casing or outer enclosure 102 that defines or closes off a chamber in which the constituent electronic components of electronic device 100 are contained. In some aspects, it is contemplated that device 100 may be a portable or mobile communications device, an in-ear device, portable time piece or any other device within which a transducer may be implemented. Enclosure 102 may include an enclosure wall 104 that separates a surrounding environment from an encased space or interior chamber 106 formed within enclosure 102. In some cases, the enclosure wall 104 completely isolates or seals the entire, or a portion of, interior chamber 106 from the surrounding environment. For example, the enclosure wall 104 may form a water-proof or acoustically isolated portion of interior chamber 106 which is impermeable to water and /or air. The interior chamber 106 may be of a sufficient volume and/or size to accommodate the constituent components of electronic device 100. The enclosure wall 104 may also include one or more of an acoustic port 108. The acoustic port 108 may be, for example, a sound output port through which sound from a speaker positioned within interior chamber 106 may be output. In other aspects, where a microphone is positioned near enclosure acoustic port 108, it could be a sound input port to allow for input of sound to the microphone.

Representatively, in one aspect shown in FIG. 1, enclosure acoustic port 108 is an acoustic port that is acoustically open to a transducer 110 positioned within interior chamber 106. In some aspects, transducer 110 may be any type of electroacoustic transducer capable of converting an electrical audio signal into a sound or a sound into an electrical audio signal. Representatively, transducer 110 may be a speaker or a micro-speaker, for example, a miniaturized version of a loudspeaker that uses a moving coil motor to drive sound output. Thus, in some aspects, transducer 110 may be referred to herein as a micro-speaker. In other aspects, where transducer 110 converts sound into an electrical audio signal, it may further be referred to herein as a microphone. In some aspects, transducer 110 may be coupled to an interior wall 122 and be considered to divide interior chamber 106 into a front volume chamber 106A and a back volume chamber 106B around transducer 110. In the case where transducer 110 is a speaker, front volume chamber 106A may form a chamber having a first volume (V1) around the sound output face or surface 110A of transducer 110. The front volume chamber 106A (and first volume V1) may be considered acoustically coupled to, or otherwise open to, acoustic port 108. In this aspect, sound pressure waves output from surface 110A of transducer 110 may pass through front volume chamber 106A and out to the surrounding ambient environment 112 through acoustic port 108. Back volume chamber 106B may have a second volume (V2) and surround the back side of transducer 110 (e.g., the side of transducer 110 opposite surface 110A).

It is recognized that, for example, a size, volume, pressure or other aspects of front volume chamber 106A or back volume chamber 106B may impact the acoustic performance of transducer 110. Thus, modifying the size, volume and/or pressure of front volume chamber 106A and/or back volume chamber 106B may be used to tune the acoustic performance of transducer 110. For example, in some cases, it may be desirable for front volume chamber 106A and/or back volume chamber 106B to be isolated or sealed (e.g., high impedance) from the ambient environment 112 to achieve the desired acoustic performance. In other cases, it may be desirable for front volume chamber 106A and/or back volume chamber 106B to have a very open path (e.g., low impedance) and/or have some amount of leak to the surrounding ambient environment 112. In still further aspects, it may be desirable for front volume chamber 106A to have a leak, or otherwise be open to, back volume chamber 106B.

With this in mind, valve assemblies or valve(s) 114, 116 and/or 118 may further be provided to vent an associated chamber. Valve 114, 116, and/or 118 may open and/or close an opening 120 from front volume chamber 106A and/or back volume chamber 106B to the ambient environment 112, or an opening 120 between front and back volume chambers 106A-B. In some aspects, opening 120 may be a vent, port, or any other suitable opening that allows for fluid communication from one chamber to another or a surrounding environment. Representatively, valve 114 may open, substantially open, close and/or substantially close opening 120 formed through wall 104 between front volume chamber 106A and ambient environment 112. In other words, when valve 114 is open or substantially open, front volume chamber 106A can leak or vent to ambient environment 112 and when valve 114 is closed, the leak or venting is prevented. A leak or venting may be desired from front volume chamber 106A where, for example, device 100 is an in-ear earpiece sealed within the user’s ear but a more open feel is desired. Valve 116 may open, substantially open, close and/or substantially close opening 120 through wall 104 between back volume chamber 106B and ambient environment 112. In other words, when valve 116 is open or substantially open, front volume chamber 106A can leak or vent to back volume chamber 106B, and when valve 116 is closed, the leak or venting is prevented. Valve 118 may open, substantially open, close and/or substantially close opening 120 through wall 122 between front volume chamber 106A and back volume chamber 106B. In this aspect, when valve 118 is open or substantially open, back volume chamber 106B can leak or vent to back volume chamber 106B, and when valve 118 is closed or substantially closed, the leak or vent is prevented. In still further aspects, it is contemplated that one or more of valves 114, 116, 118 could be used to open, substantially open, close and/or substantially close an opening (e.g., opening 120) which is to another type of acoustic chamber, for example, an opening to an acoustic resonator or attenuator coupled to one or more of the previously discussed chambers or ports of the transducer.

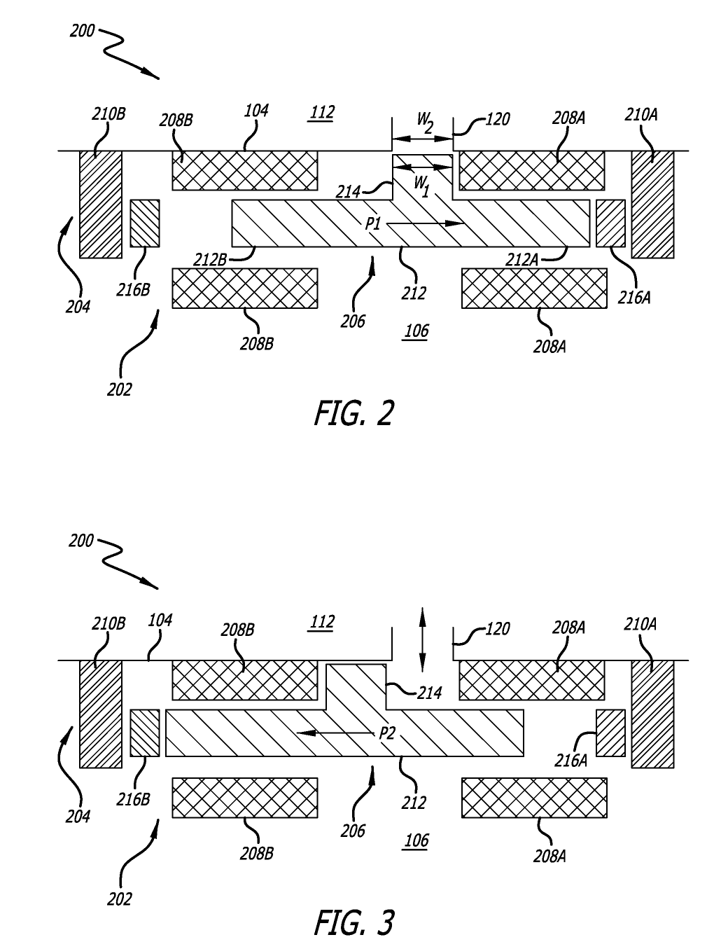

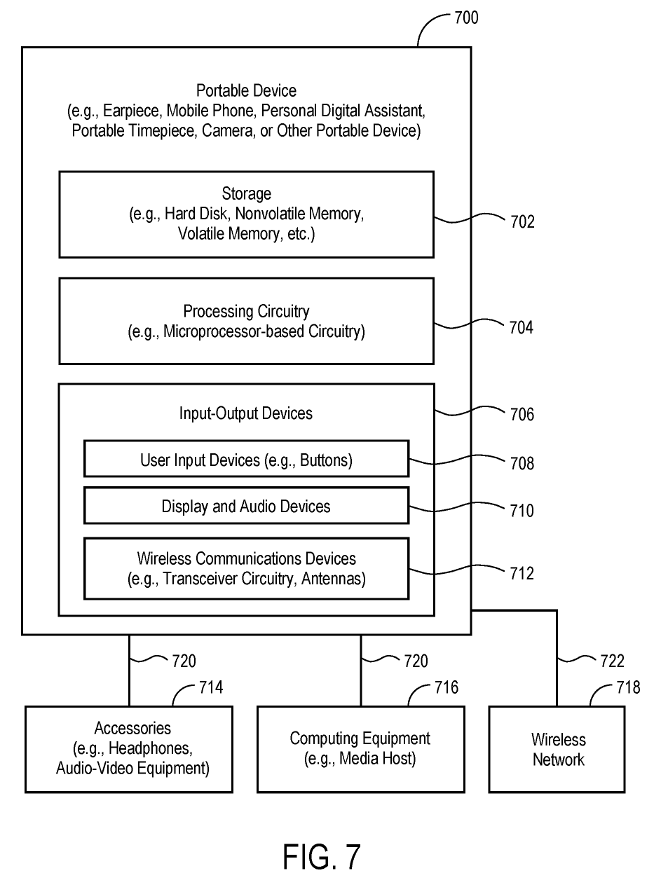

In one aspect, one or more of valves 114, 116, 118 may be electro-magnetic valves that open and/or close in response to the application of a voltage. In this aspect, valves 114, 116, 118 may be dynamically actuated to control the amount of leak. In some aspects, one or more of valves 114, 116, 118 may be micro-electromechanical systems (MEMS) actuators or valves. Valves 114, 116, 118 may be the same, or may be different. In some aspects, one or more of valves may offer the advantages of bistability, low power consumption switching from on/off states, digitization for controlling a percentage or amount of open area for venting, and/or silent operation. A number of representative configurations for valves 114, 116, 118 will now be described in reference to FIG. 2- FIGS. 7.

Referring now to FIG. 2 and FIG. 3, FIG. 2 illustrates a cross-sectional side view of one aspect of a portable electronic device having a valve assembly in a closed state or position and FIG. 3 illustrates the valve assembly in an open state or position. From this view, it can be seen that the device 200 includes a valve assembly 202 (which may be any one of the previously discussed valve assemblies 114, 116, 118) having a stationary portion 204 connected or mounted to the enclosure wall 104 and a movable portion 206 that moves relative to the stationary portion 204 and opening 120 formed through enclosure wall 104. The stationary portion 204 includes a pair of coils 208A-B, a pair of magnets 210A-B, and a pair of damping members 216A-B. The movable portion 206 includes an elongated member such as a bar or rod 212 that moves or slides in the direction of the arrow. In some aspects, the bar or rod 212 may be a steel or ferromagnetic bar or rod. A protrusion 214 extends from one side of bar or rod 212 to either close or open the opening 120 to, for example, a surrounding environment 112. Representatively, to actuate rod 212 to move in the direction of the arrow to open or close the opening, a coil 208A and magnet 210A are mounted to enclosure wall 104 along one side of opening 120 and close together to generate the required repulsion force over rod 212. The other coil 208B and magnet 210B are mounted to enclosure wall 104 along another side of opening 120 and close together to generate the required repulsion force. Rod 212 may be a steel rod having an end 212A positioned through coil 208A and near magnet 210A, and another end 212B positioned through coil 208B and near magnet 210B. In addition, damping member 216A may be positioned between rod end 212A and magnet 210A and damping member 216B may be positioned between rod end 212B and magnet 210B to prevent the ends 212A-B or rod 212 from contacting or otherwise getting too close to magnets 210A-B. During operation, a voltage may be applied to one or more of coils 208A-B to energize the coils 208A and/or 208B and generate the required repulsion force over rod 212 and cause rod 212 to slide toward magnet 210A to state or a position (P1) as illustrated by the arrow. Damping member 216A prevents the rod end 212A from contacting magnet 210A but allows rod 212 to get close enough to magnet 210A that the attraction force can hold the rod 212 in position. When rod 212 slides toward magnet 210A to position P1 the protrusion 214 is aligned with and covers opening 120 to close opening 120 off from the surrounding environment 112 as illustrated by FIG. 2. In some aspects, valve assembly 202 may be bistable such that rod 212 and protrusion 214 remain in the closed position or state illustrated by FIG. 2 when the voltage is removed. In this aspect, no power draw occurs when the device is not in use. Once rod 212 is in the desired position (P1) the voltage can be removed and rod 212 stays at the selected location due to the attraction force between rod end 212A and the magnet 210A. Application of a further voltage to coils 208A and/or 208B then causes rod 212 to slide toward magnet 210B to state or position (P2) as illustrated by FIG. 3. Rod 212 may remain in the state or position (P2) even when the voltage is removed due to the attraction force between rod end 212B and the magnet 216B. Damping member 216B prevents rod end 212B from contacting magnet 210B but allows rod 212 to get close enough to magnet 210B to hold rod 212 in position. When rod 212 sides toward magnet 210B the protrusion 214 is no longer aligned with and covering opening 120 such that opening 120 is now open to the surrounding environment 112 as illustrated by FIG. 3. It should further be understood that although two states or positions P1 and P2 are illustrated, namely a closed state P1 and an open state P2, it is contemplated that rod 212 may slide to other states or positions in which protrusion 214 only partially covers or uncovers opening 120. In still further aspects, although protrusion 214 is shown having the same width (W1) as the width (W2) of opening 120, the width (W1) of protrusion 214 may be different than the width (W2) of opening 120 to achieve more acoustically open or more acoustically closed states or positions P1-P2. For example, in some aspects, there may be a small gap or space between protrusion 214 and the enclosure wall 104 such that even in the closed position P1, there is some minimal amount of leak. If, however, the width (W1) of protrusion 214 is greater than the width (W2) of opening 120, protrusion 214 may overlap more of enclosure wall 104 and a more acoustically closed position P1 may be achieved. Thus, while in some aspects, the states or positions P1-P2 illustrated in FIGS. 2-3 may be referred to as closed or open positions or states because they are the positions in which the valve assembly 202 opens or closes the opening 120, in other aspects, the states or positions P1-P2 may be referred to or understood as corresponding to an acoustic impedance achieved at these states or positions P1-P2. For example, at state or position P1 where protrusion 214 entirely covers (but does not seal) opening 120, the acoustic impedance may be high therefore this may be a high acoustic impedance state or position. On the other hand, at state or position P2 wherein protrusion 214 does not cover opening 120, the acoustic impedance may be low therefore this may be a low acoustic impedance state or position. In addition, in some aspects, an opening or vent may further be formed through the bar or rod 212 to further decrease acoustic impedance when the rod 212 is in the open position (e.g., position P2).

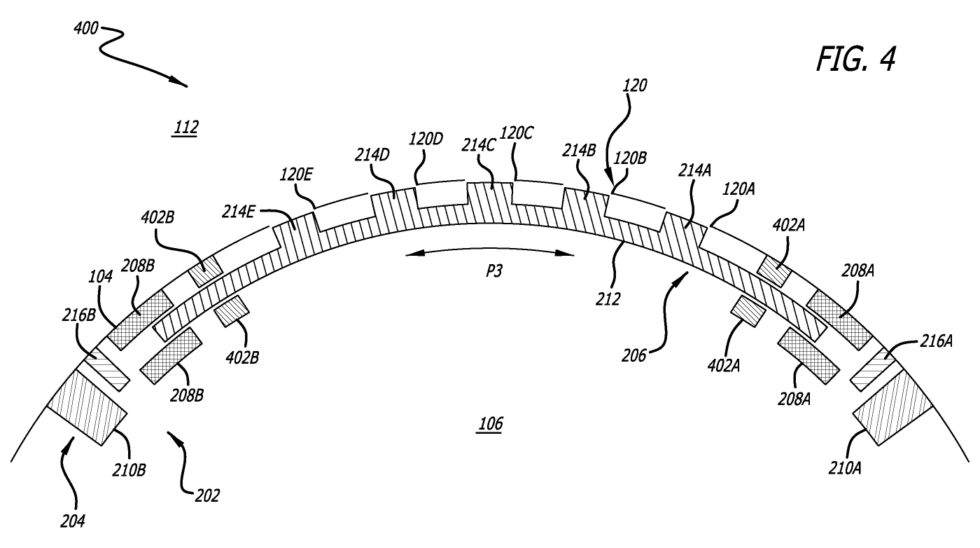

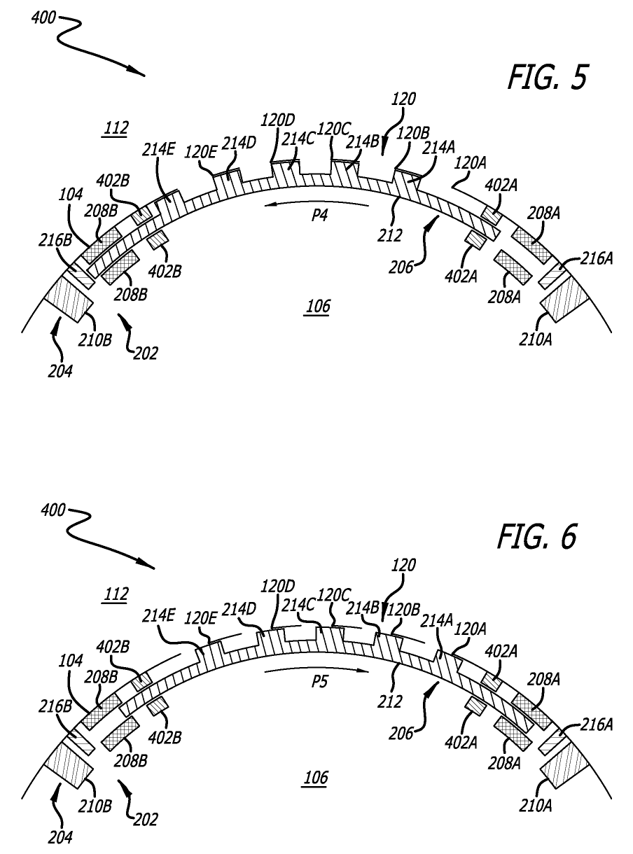

Referring now to FIGS. 4-6, FIGS. 4-6 illustrate another aspect of an electronic device 400 and valve assembly 202. Electronic device 400 and valve assembly 202 are similar to the electronic device 200 and valve assembly 202 disclosed in reference to FIG. 2 and include an enclosure (e.g., enclosure 102) having an enclosure wall 104 forming a chamber 106 around, for example a transducer, and an opening 120 from chamber 106 to surrounding ambient environment 112. In addition, valve assembly 202 includes a stationary portion 204 having a pair of coils 208A-B, a pair of magnets 210A-B and a pair of damping members 216A-B, and a movable portion 204 including a ferromagnetic or steel rod 212. In this configuration, however, opening 120 includes a number of openings 120A, 120B, 120C, 120D, 120E and bar or rod 212 slides along enclosure wall to open/close openings 120A-E. Representatively, a total volume or surface area of opening 120 is made up of separate discretized openings 120A-E that may be closed (covered) or opened (uncovered) by valve assembly 202 to increase or decrease a total volume or surface area of opening 120. In this aspect, valve assembly 202 may further include a number of protrusions 214A, 214B, 214C, 214D, 214E extending from rod 212 that are dimensioned to close (cover) or open (uncover) openings 120A-E when the movable rod 212 slides relative to openings 120A-E as illustrated by the arrow. In addition, since in this configuration enclosure wall 104 and rod 212 are curved, rod 212 moves along an arcuate pathway illustrated by the arrow to close/open openings 120A-E. In still further aspects, to maintain a proper alignment and reduce friction as rod 212 moves along the arcuate pathway relative to enclosure wall 104, bearings 402A, 402B may be mounted to enclosure wall 104 and positioned around rod 212. FIG. 4 illustrates valve assembly 202 in a closed state or position of high impedance P3 in which each of protrusions 214A-E entirely cover or overlap each of openings 120A-E. FIG. 5 illustrates valve assembly 202 in an open state or position of low impedance P4 in which each of protrusions 214A-E do not cover or close any of openings 120A-E. FIG. 6 illustrates valve assembly 202 in a partially open and partially closed state or position of medium impedance P5 in which each of protrusions 214A-E only partially cover each of openings 120A-E. It is further contemplated that in some aspects, openings 120A-E may be incrementally closed by valve assembly 202. For example, valve assembly 202 may include one or more of protrusions 214A-E dimensioned relative to openings 120A-E to completely close or cover one or more of openings while other openings remain completely or partially open. In addition, it should be understood that while only five openings 120A-E are shown and described in the cross-sectional view of FIGS. 4-5, opening 120 may be made up of more or fewer than five openings 120A-E, and rod 212 may have a corresponding number of protrusions to cover openings 120A-E.

FIG. 7 illustrates a block diagram of one aspect of an electronic device within which the previously discussed transducer and/or valve assembly may be implemented. As shown in FIG. 7, device 700 may be any type of electronic device within which a transducer and/or valve assembly disclosed herein may be desired, for example, a desktop device such as a computer or speaker, a mobile phone, personal digital assistant, portable timepiece, camera, an in-ear earpiece (e.g., a hearing aid or the like), an over the ear earpiece, or other portable device. Device 700 may include storage 702. Storage 702 may include one or more different types of storage such as hard disk drive storage, nonvolatile memory (e.g., flash memory or other electrically-programmable-read-only memory), volatile memory (e.g., battery-based static or dynamic random-access-memory), etc.

Processing circuitry 704 may be used to control the operation of device 700. Processing circuitry 704 may be based on a processor such as a microprocessor and other suitable integrated circuits. With one suitable arrangement, processing circuitry 704 and storage 702 are used to run software on device 700, such as internet browsing applications, voice-over-internet-protocol (VOIP) telephone call applications, email applications, media playback applications, operating system functions, etc. Processing circuitry 704 and storage 702 may be used in implementing suitable communications protocols. Communications protocols that may be implemented using processing circuitry 704 and storage 702 include internet protocols, wireless local area network protocols (e.g., IEEE 802.11 protocols--sometimes referred to as Wi-Fi®), protocols for other short-range wireless communications links such as the Bluetooth® protocol, protocols for handling 3G or 4G communications services (e.g., using wide band code division multiple access techniques), 2G cellular telephone communications protocols, etc.

To minimize power consumption, processing circuitry 704 may include power management circuitry to implement power management functions. For example, processing circuitry 704 may be used to adjust the gain settings of amplifiers (e.g., radio-frequency power amplifier circuitry) on device 700. Processing circuitry 704 may also be used to adjust the power supply voltages that are provided to portions of the circuitry on device 700. For example, higher direct-current (DC) power supply voltages may be supplied to active circuits and lower DC power supply voltages may be supplied to circuits that are less active or that are inactive. If desired, processing circuitry 704 may be used to implement a control scheme in which the power amplifier circuitry is adjusted to accommodate transmission power level requests received from a wireless network.

Input-output devices 706 may be used to allow data to be supplied to device 700 and to allow data to be provided from device 700 to external devices. Display screens, microphone acoustic ports, speaker acoustic ports, and docking ports are examples of input-output devices 706. For example, input-output devices 706 can include user input-output devices 708 such as buttons, touch screens, joysticks, click wheels, scrolling wheels, touch pads, key pads, keyboards, microphones, cameras, etc. A user can control the operation of device 700 by supplying commands through user input devices 708. Display and audio devices 710 may include liquid-crystal display (LCD) screens or other screens, light-emitting diodes (LEDs), and other components that present visual information and status data. Display and audio devices 710 may also include audio equipment such as speakers and other devices for creating sound. Display and audio devices 710 may contain audio-video interface equipment such as jacks and other connectors for external headphones and monitors.

Wireless communications devices 712 may include communications circuitry such as radio-frequency (RF) transceiver circuitry formed from one or more integrated circuits, power amplifier circuitry, passive RF components, antennas, and other circuitry for handling RF wireless signals. Wireless signals can also be sent using light (e.g., using infrared communications). Representatively, in the case of a speaker acoustic port, the speaker may be associated with the port and be in communication with an RF antenna for transmission of signals from the far end user to the speaker.

Returning to FIG. 7, device 700 can communicate with external devices such as accessories 714, computing equipment 716, and wireless network 718 as shown by paths 720 and 722. Paths 720 may include wired and wireless paths. Path 722 may be a wireless path. Accessories 714 may include headphones (e.g., a wireless cellular headset or audio headphones) and audio-video equipment (e.g., wireless speakers, a game controller, or other equipment that receives and plays audio and video content), a peripheral such as a wireless printer or camera, etc.

Computing equipment 716 may be any suitable computer. With one suitable arrangement, computing equipment 716 is a computer that has an associated wireless access point (router) or an internal or external wireless card that establishes a wireless connection with device 700. The computer may be a server (e.g., an internet server), a local area network computer with or without internet access, a user's own personal computer, a peer device (e.g., another portable electronic device), or any other suitable computing equipment.

Wireless network 718 may include any suitable network equipment, such as cellular telephone base stations, cellular towers, wireless data networks, computers associated with wireless networks, etc. For example, wireless network 718 may include network management equipment that monitors the wireless signal strength of the wireless handsets (cellular telephones, handheld computing devices, etc.) that are in communication with network 718.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. The description is thus to be regarded as illustrative instead of limiting. For example, although a speaker is specifically disclosed herein, the valve disclosed herein could be used with other types of transducers, for example, microphones. In addition, in some aspects, the valve could be used to open/close the opening to a chamber other than an interior chamber of a transducer. Still further, although portable devices such as in-ear earphones, headphones and the like are described, the valve could be used to open/close a chamber associated with other types of devices, for example, a desktop device such as a computer or a speaker, a tablet computer, personal computer, laptop computer, and/or a notebook computer. In addition, to aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. A portable electronic device comprising:
an enclosure having an enclosure wall that forms an interior chamber surrounding a transducer and an opening from the interior chamber; and
an electro-magnetic valve coupled to the opening and comprising a stationary portion that is energized upon application of a voltage to drive a movement of a movable portion between a first state and a second state operable to close or open the opening.

2. The portable electronic device of claim 1 wherein the electro-magnetic valve comprises a bistable electro-magnetic valve.

3. The portable electronic device of claim 1 wherein the movable portion comprises an elongated member that slides across the opening to the first state to close the opening and the second state to open the opening.

4. The portable electronic device of claim 1 wherein the stationary portion comprises a pair of magnets and a pair of coils that are energized to move a steel bar of the movable portion between the first state and the second state to close or open the opening.

5. The portable electronic device of claim 4 wherein each magnet of the pair of magnets and each coil of the pair of coils are positioned near ends of the steel bar, and the stationary portion further comprises a damping member positioned between each of the ends of the steel bar and each magnet.

6. The portable electronic device of claim 1 wherein the opening comprises a number of openings and the movable portion comprises a number of protrusions, and the number of protrusions cover at least one of the number of openings in the first state to close the opening.

7. The portable electronic device of claim 6 wherein the number of protrusions cover all of the number of openings in the first state to close the opening.

8. The portable electronic device of claim 1 wherein the first state corresponds to a first acoustic impedance in which the opening is substantially closed and the second state corresponds to a second acoustic impedance in which the opening is substantially open.

9. The portable electronic device of claim 1 wherein the enclosure wall comprises a curved interior surface and the movable portion comprises a curved steel bar that slides along the curved interior surface of the enclosure wall.

10. The portable electronic device of claim 1 wherein the opening is through a portion of the enclosure wall that separates the interior chamber from an ambient environment, and wherein opening and closing the opening opens and closes the interior chamber to the ambient environment.

11. A valve assembly for a portable electronic device comprising:
an electro-magnetic valve coupled to an opening defined by an enclosure wall that forms an interior chamber surrounding a transducer and the electro-magnetic valve comprising a stationary portion that is energized upon application of a voltage to drive a movement of a movable portion between a first state and a second state operable to close or open the opening.

12. The valve assembly of claim 11 wherein the electro-magnetic valve comprises a bistable electro-magnetic valve.

13. The valve assembly of claim 11 wherein the movable portion comprises an elongated member that slides across the opening to the first state to close the opening and the second state to open the opening.

14. The valve assembly of claim 11 wherein the stationary portion comprises a pair of magnets and a pair of coils that are energized to slide a steel bar of the movable portion through the pair of coils between the first state and the second state to close or open the opening.

15. The valve assembly of claim 14 wherein each magnet of the pair of magnets and each coil of the pair of coils are positioned near ends of the steel bar, and the stationary portion further comprises a damping member positioned between each of the ends of the steel bar and each magnet.

16. The valve assembly of claim 11 wherein the opening comprises a number of openings and the movable portion comprises a number of protrusions, and the number of protrusions cover at least one of the number of openings in the first state to close the opening.

17. The valve assembly of claim 16 wherein the number of protrusions cover all of the number of openings in the first state to close the opening.

18. The valve assembly of claim 11 wherein the first state corresponds to a first acoustic impedance in which the opening is substantially closed and the second state corresponds to a second acoustic impedance in which the opening is substantially open.

19. The valve assembly of claim 11 wherein the enclosure wall comprises a curved interior surface and the movable portion is curved and slides along the curved interior surface of the enclosure wall.

20. The valve assembly of claim 11 wherein the opening is through a portion of the enclosure wall that separates the interior chamber from an ambient environment, and wherein opening and closing the opening opens and closes the interior chamber to an ambient environment.
